(19) United States
(12) Patent Application Publication
(10) Pub. No.: US 2023/0121165 A1
(43) Pub. Date: Apr. 20, 2023

(54) EXTENDED-RELEASE COMBINED FERTILIZER AND HUMIC GRANULES

(71) Applicant: The Andersons Inc., Maumee, OH (US)

(72) Inventor: Joseph Shumski, Maumee, OH (US)

(73) Assignee: The Andersons Inc., Maumee, OH (US)

(21) Appl. No.: 17/961,236

(22) Filed: Oct. 6, 2022

Related U.S. Application Data
(60) Provisional application No. 63/252,661, filed on Oct. 6, 2021.

(51) Int. Cl. C05G 3/40; C05C 9/00; C05G 5/30

(52) U.S. Cl. CPC C05G 3/40; C05C 9/00; C05G 5/37

(57) ABSTRACT

A granule defined by a shape and a size, including a mass formed of a plurality of soluble fertilizer particles and a plurality of humic particles and an extended-release polymer coating surrounding an exterior surface of the mass. A process for forming the granule includes providing a mass of a plurality of soluble fertilizer particles and a plurality of humic particles and applying an extended-release coating to an exterior surface of the mass. The granule is used in a method for enhancing root growth of a target plant, such as turf grass, by applying a plurality of the granules to the target plant and allowing sufficient time for extended release of nutrients and humics from the plurality of granules.

### RELATED APPLICATIONS

This application claims priority benefit of U.S. Provisional Application Ser. No. 63/252,661 filed on Oct. 6, 2022, the contents of which are hereby incorporated by reference.

### FIELD OF THE INVENTION

The present invention relates in general to a fertilizer and in particular to coated particulate fertilizer combined with humate to afford granules that have extended-release capabilities.

### DESCRIPTION OF THE RELATED ART

Fertilizer is any organic or inorganic material of natural or synthetic origin that is added to a soil to supply one or more plant nutrients essential to the growth of cultivated vegetation. Fertilizers typically provide, in varying proportions: six macronutrients: nitrogen (N), phosphorus (P), potassium (K), calcium (Ca), magnesium (Mg), and sulfur (S); and eight micronutrients: boron (B), chlorine (Cl), copper (Cu), iron (Fe), manganese (Mn), molybdenum (Mo), zinc (Zn) and nickel (Ni). Only three other macronutrients are required by all plants: carbon, hydrogen, and oxygen, which are supplied by water (through rainfall or irrigation) and carbon dioxide in the atmosphere. Compound fertilizers often combine N, P and K fertilizers into easily dissolved pellets. The N:P:K ratios quoted on fertilizers give the weight percent of the fertilizer in nitrogen (N), phosphate (P₂O₅) and potash (K₂O equivalent).

Fertilizer application to large areas of cultivated vegetation such as golf courses, parks, lawns, gardens and woodlands has generally been broadcast application of granular products containing an agent, for example via rotary spreader. Granular materials have the advantage of not being susceptible to drift or the field solvation associated with liquid fertilizers. Agents that can be deployed in a granular form include plant nutrients, fertilizer, and pesticides. Using granular products having particle sizes in the range of about 0.5 millimeter to about 15 millimeters, an operator can cover a large area with minimal distance traversed by the spreader itself, while applying the granular products relatively uniformly to the desired area. While efforts have been made to use crystallized urea particles alone, urea particles are both hygroscopic and are prone to breakage with dusting occurring thereafter.

Besides N—P—K values, there is a growing appreciation that fulvic and humic acids provide a rich carbon source for maintaining and improving soil biology. Fulvic and humic acids have numerous proven benefits for soil and plant health which include: enhanced nutrient efficiency, micronutrient uptake, soil nutrient holding capacity, biological activity, and water holding capacity. Both fulvic and humic acids have unique physical and chemical properties that contribute to their effectiveness and the way they complement fertilizer programs. Fulvic acids are very soluble (>80 mg/L) and can be readily absorbed by leaves and roots, making them well suited for foliar application. Fulvic acids enhance the absorption of nutrients and aid in the efficiency of plant metabolic reactions. Humic acids in contrast, are less water soluble, have a pH dependence to the solubility and have a high cation exchange capacity (CEC), which helps enhance the nutrient holding capacity of the soil after application. Humic acid molecules chelate many essential nutrients and help stimulate soil microbiology. Unfortunately, fulvic acid and humic acid tend to be low specific gravity substances that are prone to dusting thereby making powdered delivery problematic. Dissolution of these acids for spray application also tend to clog spray applicators.

A problem with many fertilizer compositions is the lack of sustained and simultaneous availability to plants of the component nutrient sources in the fertilizer. Typically, water-soluble components rapidly permeate the soil and may be lost via leaching, run-off or chemical binding with soil minerals. There is also a kinetic rate limit at which a plant can absorb nutrients with excess chemical fertilizer nutrient content not only being ineffective, but also contributing to runoff and soil microbiome damage.

A fertilizer that releases nutrients and other active materials at a slower rate can better match plant needs and uptake rates. Improved nutrient uptake decreases the amount of fertilizer required for optimum plant growth over a growing season while potentially limiting the number of applications required in the course of a growing season.

Thus, there is a continuing need for combined soluble fertilizer and humate granules that has extended-release characteristics to improve nutrient use efficiency and decreases the amount of fertilizer required for optimum plant growth over a growing season. There is a further need to improve the ease of manufacturing over existing coating processes that produce coated combined humate and fertilizer granules.

### SUMMARY OF THE INVENTION

The present invention provides a granule defined by a shape and a size, the granule including a mass formed of a plurality of soluble fertilizer particles and a plurality of humic particles and an extended-release polymer coating surrounding an exterior surface of the mass.

The present invention also provides a process for forming the granule includes providing a mass of a plurality of soluble fertilizer particles and a plurality of humic particles and applying an extended-release coating to an exterior surface of the mass.

The granule is used in an inventive method for enhancing root growth of a target plant, such as turf grass, by applying a plurality of the granules to the target plant and allowing sufficient time for extended release of nutrients and humics from the plurality of granules.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is a schematic cross-sectional view of an inventive granule with a core-shell construct;

FIG. 2A is a schematic cross-sectional view of the inventive granule with a hemispherical construct;

FIG. 2B is a schematic cross-sectional view of the inventive granule with a hemispherical construct with a coating between the hemispheres;

FIG. 3A a schematic cross-sectional view of the inventive granule with a multiple layer core-shell construct;

FIG. 3B a schematic cross-sectional view of the inventive granule with an alternative multiple layer core-shell construct;

FIG. 4 is a plot of the release kinetics of an inventive granule compared to a like granule that is uncoated; and

FIG. 5 is a color photograph of turfgrass root samples.

### DETAILED DESCRIPTION OF THE INVENTION

The present invention relates to a novel form of an extended-release granules for delivery of bioavailable fertilizer to a plant, along with humics. The resulting granules are amenable to application as free-flowing granules to promote plant growth with improved nutrient uptake resulting in increasing nutrient use efficiency and less applications being required for optimum plant growth over a growing season.

As used herein, the term “humics” refers to humic acid, fulvic acid, and salts thereof such as sodium, potassium, and calcium salts, and combinations thereof.

As used herein, the term “soluble fertilizer” refers to a substance including at least one type of N—P—K element present as an ion or a compound with a solubility in 100 milliliters of deionized water of at least 10 grams under conditions of standard temperature and pressure (STP). Soluble fertilizers operative herein illustratively include potassium sulfate (sulfate of potash), potassium nitrate (nitrate of potash), potassium metaphosphate, potassium chloride (muriate of potash), dipotassium carbonate, or potassium oxide, ammonium salts, such as metal ammonium phosphates, ammonium nitrate, ammonium sulfate, urea, coated urea, monoammonium phosphate, and diammonium phosphate; dicyandiamide, carbodiimides, crotilidiene diurea, nitrocellulose, calcium nitrate, or combinations thereof.

As used herein, the term “water soluble” in the context of an extended release polymer coating refers to a polymer with a solubility in 100 milliliters of deionized water of at least 2 grams under conditions of standard temperature and pressure (STP). Conversely, a polymer below the threshold for water soluble is defined as water insoluble.

It is to be understood that in instances where a range of values are provided herein, that the range is intended to encompass not only the end point values of the range, but also intermediate values of the range as explicitly being included within the range and varying by the last significant figure of the range. By way of example, a recited range of from 1 to 4 is intended to include 1-2, 1-3, 2-4, 3-4, and 1-4.

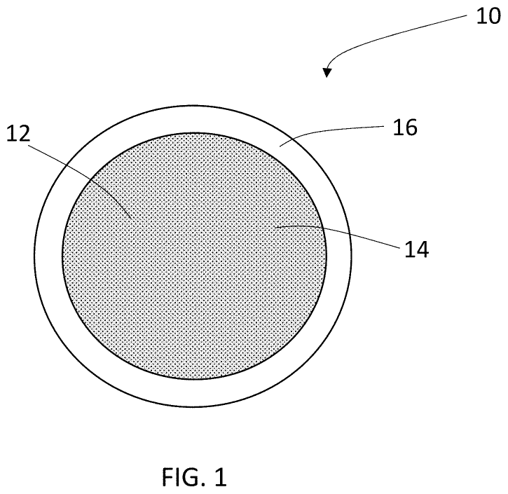

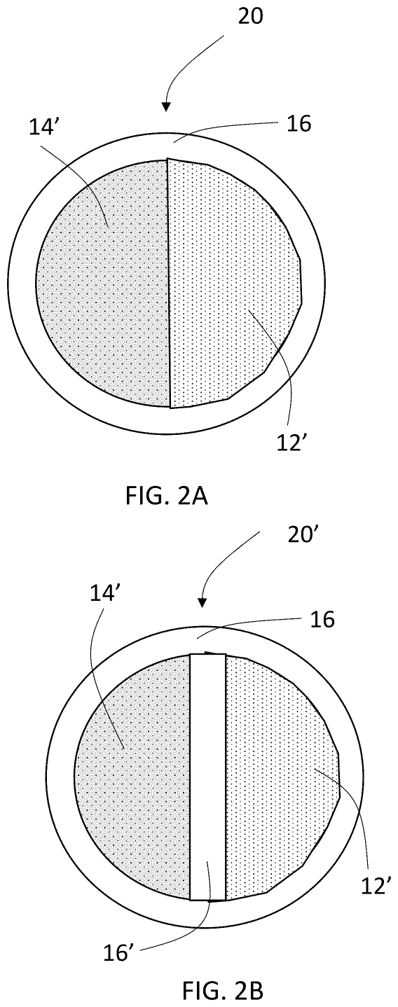

Embodiments of the invention combine a water soluble fertilizer based fertilizer with a humic and an extended-release coating. According to some inventive embodiments, the soluble fertilizer and humic are intermixed products formed by co-melting, co-mingling constituent particles combined with minimal water to adhere the particles together and tumbling to form a granule, co-mingling constituent particles combined with a liquid binder to adhere the particles together and tumbling to form a granule, or a combination thereof. The particles of soluble fertilizer and humic are readily combined in a core-shell construct (FIG. 1), or domains of soluble fertilizer and humic joined such that each domain forms a spherical cap, spherical wedge or spherical sector relative to the others. In the simplest instance of two like sized domains with one each of soluble fertilizer and humics, hemispherical domains occur (FIG. 2A). Such constructs absent an extended release coating are disclosed in US20180222810A1.

An extended-release coating is provided to slow the release of the inventive granule soluble fertilizer and humics into a soil upon dispersion. Extended release coatings according to the present invention are polymeric in nature and regardless of the mechanism of action delay infiltration of water into the particle interior where the humics and water soluble fertilizer are dissolved and the resulting solution or suspension containing bioavailable nutrients for a proximal target plant seep from the particle interior. An extended release coating according to the present invention is formed from a water insoluble polymer under conditions that result in coating porosity that slows the water transport into the particle interior, a water soluble polymer is also operative herein to form an extending release coating through a mechanism of sacrificial dissolution thereby delaying soil moisture from coming into contact with the particle internal water soluble fertilizer and humics, or a combination thereof. Regardless of whether the polymer is water insoluble or water soluble, in some inventive embodiments the polymer is biodegradable.

Generally, a water insoluble polymer is applied at 0.5 to 11 total weight percent with the specific amount of water insoluble polymer is dictated by factors that include in part: the size of the particle prior to overcoating, percentage of pore area, and friability thereof. A water insoluble polymer coating is provided on the exterior surface of the particle. In some inventive embodiments, a water insoluble polymer is also intermixed within domains internal to the particles, forms boundaries between the fertilizer and humics domains, or combinations thereof. It is appreciated applying a water insoluble polymer as a coating from a solvent too quickly causes the formation of bubbles that lead to the formation of numerous small pores in the coating film. A water insoluble polymer operative herein illustratively includes a sodium salt of carboxylic acid copolymer dispersant and a polyol, a latex, a polyurethane, a polyurea, a polylactic acid, polycaprolactone, polybutylene succinate, polybutylene succinate adipate, aliphatic-aromatic copolyesters, polybutylene adipate/terephthalate, polymethylene adipate/terephthalate, and a copolymer including at least 50 weight percent of any of the aforementioned polymers. Typical weight average molecular weight of water insoluble polymers range from 3,000 and 500,000 atomic mass units.

Generally, a water soluble polymer is applied at 4 to 18 total weight percent with the specific amount of water soluble polymer is dictated by factors that include in part: the size of the particle prior to overcoating, percentage of pore area, and friability thereof. A water soluble polymer coating is provided on the exterior surface of the particle. In some inventive embodiments, a water soluble polymer is also intermixed within domains internal to the particles, forms boundaries between the fertilizer and humics domains, or combinations thereof. A water soluble polymer operative herein illustratively includes dextran, starch, poly((meth)acrylic acid), poly(vinyl hydroxyethylcellulose, alginates, agar, gelatin, mucilage and mixtures thereof. Typical weight average molecular weight of water insoluble polymers range from 2,000 and 100,000 atomic mass units.

In a specific method of forming an inventive particle, a homogeneous mass is formed by mixing grains or powders of humate and soluble fertilizer together prior to formation of the granule. In a specific inventive embodiment, powders of humic and urea are both wetted with water to form a slurry that is then formed into a homogenous mass that is ground and coated with an extended-release coating to form granules, while in other embodiments, the slurry is pan agglomerated and dried to form each homogenous mass, which are then coated with an extended-release coating.

In some inventive embodiments, the mass of soluble fertilizer and humic is overcoated with anti-dusting agent prior to the extended-release coating being applied. Anti-dusting agents operative herein illustratively include mineral oil, vegetable oil, animal-based oils, or combinations thereof. The anti-dusting agent is typically applied as a solubilized or neat spray onto a particle prior to, or on top of the extended release coating.

The granules of the present invention have a mean domain size that ranges from 0.1 mm to 10 mm. In specific embodiments, the mean domain size ranges from 0.3 mm to 8 mm while in still other embodiments the mean domain size ranges from 0.5 mm to 5 mm. The homogeneous combined urea and humate granules are typically spherical owing to formation in a tumbler, but other shapes such as cylindrical and irregular are operative herein. When non-spherical shapes are used, the domain size refers to the longest linear dimension of the granule. In specific inventive embodiments, no binder it present between the humics and soluble fertilizer in the inventive granule; while in other embodiments, micronutrients, biostimulants, other N—P—K contributing salts, or a combination thereof are formed into fine granules that are admixed with the humics, the fine granules being sized such that greater than 90 weight percent of the granules are between +400 and −40 standard mesh size (US Sieve). Soil micronutrients operative herein illustratively include calcium, magnesium, sulfur, iron, manganese, copper, zinc; oxides thereof, salts thereof and combinations thereof. Biostimulants are substances that promote plant survival and health and illustratively include plant growth hormones and plant growth regulators such as cytokinins, auxins, gibberellins, ethylene, absisic acid and a combination thereof. Additives operative herein illustratively including fillers, desiccants, colorants, fragrances, and combinations thereof. Such additives, if present make up between 0.01 and 20 total weight percent of the inventive granule.

An inventive granule promotes the growth of targeted desirable organisms illustratively including cultivated plants such as lawn grass, crops, flowers, shrubs, trees and bushes. The inventive granules are configured to release nutrients and other active materials within the granule at a slower rate than a conventional granule, thereby providing the targeted organisms with a better opportunity to uptake the necessary nutrients. Improved nutrient uptake increases nutrient use efficiency and decreases the amount of fertilizer required for optimum plant growth over a growing season. Furthermore, by decreasing the amount of fertilizer used and increasing the efficiency of nutrient uptake, less fertilizer may be used, and this may reduce the impact on the environment and the money spent on fertilizers.

The bioavailable nitrogen containing ingredient is present in amounts ranging from 90% to 99.9% by weight of the total dry weight of the granule and for example for a 2.2 mm urea granule with 2% humics represents a 44-0-0 NPK value material.

FIG. 1 is a cross-sectional view of an inventive homogenous potassium humate/urea granule shown generally at 10. The granule 10 has a homogeneous mixture of urea 12 and humics 14 surrounded by a extended-release coating 16. Micronutrients, biostimulants, N—P—K contributing salts, or a combination thereof may be present in the mixture as fine granules or as a solute, or a combination thereof. Additives may be present in some embodiments in the core as fine granules or a solute, or a combination thereof. The granule 10 has a domain size and a surface defined by a radius; although it is appreciated that oblong pellets are also envisioned with the scope of the present invention. In some inventive embodiments, the humic 14 is a humate and in other inventive embodiments, potassium humate.

According to embodiments, a homogenous mass of urea 12 and humics 14 is readily formed by mixing particles of urea and humics and melting the urea to include the particles of humics therein or joining the same with minimal amounts of water to make the particle surfaces slick and adherent as the particles dry. By cooling droplets of the melt, the homogenous mass of urea 12 and humics 14 is formed. Conventional techniques for cooling the melt to form homogenous masses of urea 12 and humics 14 illustratively include spray drying, a shot tower, or a drip manifold delivering melt onto a cooling substrate. According to embodiments, the homogenous masses are formed by combining particulate of humics 14 and urea 12. The particles 12 and 14 are tackified. As the particles 12 and 14 are rolled together on a pan agglomerator, a humic/urea mass 10 forms. According to embodiments, a typical humic/urea mass 10 contains from 50 to 10,000 particles 12 and 14. From the homogeneous masses, the inventive granules 10 are then formed by applying a extended-release coating to the exterior surface of the homogeneous masses. According to embodiments, the extended-release coating is applied by pouring the coating material or a curable precursor thereof into a drum in which the homogenous masses are present and mixing the materials until the extended-release coating is applied to the exterior surface of the masses. Alternatively, the extended-release coating is applied to the masses using a fan pattern spray nozzle.

FIGS. 2A and 2B show inventive granules 20 and 20′ formed from two compositionally separate portions that as shown are hemispheres where a first domain is humic-rich 14′ and formed from a melt and a second domain that is urea-rich 12′ and formed from a melt. The separate domains 12′ and 14′ are readily formed as drops on a nonstick sheet or surface prior to joining to form masses. It is appreciated that the domains 12′ and 14′ can be mutually exclusive of urea and humics, respectively; or have a minority by weight of a domain being the other component relative to the component in which a portion is enriched. While this embodiment is shown with two hemispherical portions, it is appreciated that 3, 4, 5, 6, or even more globules of molten material can be joined to form a mass containing humic and urea. In some inventive embodiments, the humic 14′ is a humate and in other inventive embodiments, potassium humate. Upon formation and joining of the domains 12′,14′ into masses, an extended-release coating 16 is applied to the exterior surface of the masses. According to other inventive embodiments, the extended-release coating is applied by dribbling the coating material into a drum in which the joined masses are present and mixing the materials until the extended-release coating is applied to the exterior surface of the masses. Alternatively, the extended-release coating is applied to the masses using a fan pattern spray nozzle. Furthermore, as shown in FIG. 2B, a layer of extended-release coating 16′ is positioned between the urea-rich 12′ and the humic-rich 14′ domains.

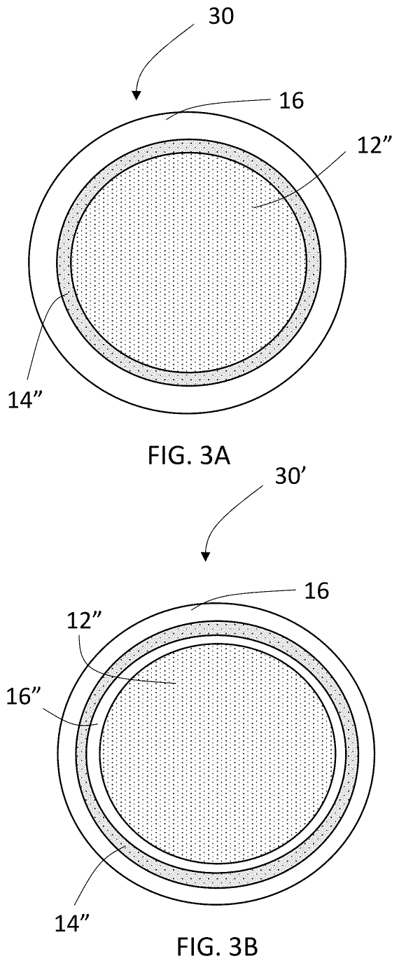

FIGS. 3A and 3B show an inventive granules 30 and 30′ formed from two compositionally separate portions that include a central fertilizer core 12″ surrounded by a humic coating 14″ in alternate cross-sectional views. The central urea core 12″ is surrounded by a humic coating 14″ to form a urea/humic mass. According to certain inventive embodiments, the central urea core 12″ surrounded by a humic coating 14″ is a product called HCU™ sold by The Andersons, Inc. that includes a urea core enrobed with a potassium humate coating that has a surface that exhibits the handling properties of potassium humate. Upon formation of the masses formed of a urea core 12″ and a humic coating 14″, an extended-release coating 16 is applied to the exterior surface of the masses. According to embodiments, the extended-release coating is applied by pouring the coating material into a drum in which the masses are present and mixing the materials until the extended-release coating is applied to the exterior surface of the masses. Alternatively, the extended-release coating is applied to the masses using a fan pattern spray nozzle. Furthermore, as shown in FIG. 3B, a layer of extended-release coating 16″ is positioned between the urea-rich core 12″ and the humic-rich coating 14″, according to embodiments.

An inventive process for making inventive granules includes starting with water soluble fertilizer domains, such as urea that are the desired size and shape. The fertilizer domains are mixed with humics and any fine particles of additives that are desired to the incorporated within a mass that will form the core of an inventive granule. In order to promote adhesion of the humics absent a binder, the mixture is subjected to process that temporarily tackifies the fertilizer granule surface. Tackifying techniques illustratively include microwave heating, convection heating, and conduction heating. To further promote adhesion, pressure is applied to the mixture, steam, a small quantity of water, alcohol, or a combination thereof are added. Without intending to be bound to a particular theory, with a finite addition of water, steam, or alcohol to only partially hydrate the contacting particles surfaces that upon recrystallization are joined. Pressure is believed to operate by melding the friable humics into the softened urea surface. In those instances when water, steam, or alcohol is added, the resulting masses are dried to assure that the granules are free-flowing. It is appreciated that the heat and secondary treatments of pressure, steam or water are conducted sequentially in either order, or simultaneously. According to certain inventive embodiments, the resulting masses are overcoated with an anti-dusting agent by conventional methods. Next, the formed masses containing homogenous masses of humic and urea, helispherical masses of urea-rich and humic-rich domains, or masses of urea cores coated with humic are overcoated with an extended-release coating. According to certain inventive embodiments, the extended-release coating is applied by dribbling the coating material into a drum in which the masses are present and mixing the materials until the extended-release coating is applied to the exterior surface of the masses. Alternatively, the extended-release coating is applied to the masses using a fan pattern spray nozzle. According to embodiments, a drum is provided at a temperature of 60-75° C. Similarly, the masses within the drum are provided at a temperature of 60-75° C. According to embodiments, the extended-release coating is heated to a temperature of 60-65° C. to ensure flowability of the material that will be formed into the extended-release coating. According to certain inventive embodiments, the materials are mixed within the drum for 3 to 15 minutes. According to embodiments, the formed granules are cooled, however, such an external cooling step is not necessary.

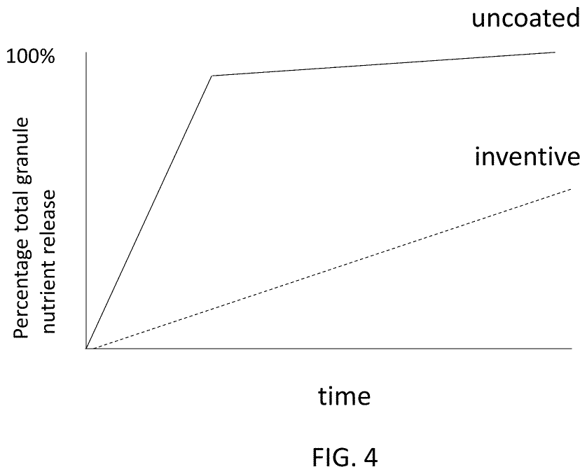

Regardless of the specifics of the formation, an inventive granule modifies release of the water soluble contents thereof. FIG. 4 is a stylized summary of various formulations according to the present invention. A gradual release of the granule contents is noted for the polymer coated granules (dashed line) relative to a like granule without the inventive coating (solid line) after normalizing the fertilizer and humic content, in which a rapid release of contents is observed. By way of a example, while an uncoated granule of a given composition may have released 90% of the nutrients in a 3 days, an inventive coated granule may have only released 10% of the contents at this stage and may take 21 days to reach the same 90% release value.

The granules of the present invention have minimal dust as measured by smoke meter opacity compared to conventional forms of soluble fertilizer with humics, even without an anti-dusting agent overcoating.

The granules of the present invention are administered to a target plant species to produce a desired effect directly on the plant, to promote the health of the soil biome in which the plant is growing, or to inhibit an undesirable organism in proximity to the target plant. Granules are administered by a method that delivers the granules to the vicinity of the plant.

### EXAMPLES

Various fertilizers, including the inventive extended-release combined soluble fertilizer and humic granule, are applied to turfgrass and evaluated for turfgrass rooting and compared to understand turfgrass rooting in response to humic fertilizers. The tests are carried out in a greenhouse with the turfgrass grown in rooting tubes that are placed at a 45 degree angle. The turfgrass tested is Kentucky Bluegrass. The test is carried out in a 56 day interval. The various fertilizers are applied at application rates as indicated in Table 1.

TABLE 1
Application Rate of Fertilizer Treatments for Turfgrass Rooting Evaluation.

| Treatment | Application Rate |
|---|---|
| 22-0-4 (Syn.) w/Black Gypsum (The | 1#N/M* |
| Andersons, Inc., Maumee, OH, USA) | |
| Inventive poly-coated humic-coated urea (PCHCU) 2.5% {what | 1#N/M |
| does 2.5% refer to? -details needed as to nature of coating, size, | |
| etc.} | |
| Urea + humic dispersing granules (HDG) | 1#N/M + 0.9#/M |
| 18-24-12 Starter Fertilizer + HDG | 1#N/M + 0.9#/M |
| 18-24-12 Starter Fertilizer alone | 1#N/M |
| Uflexx (stabilized nitrogen fertilizer) (Koch Agronomic Services, | 1#N/M |
| LLC, Wichita, KS, USA) | |
| Urea | 1#N/M |
| Non-treated | — |

Where #N denotes pounds of nitrogen and M denotes months

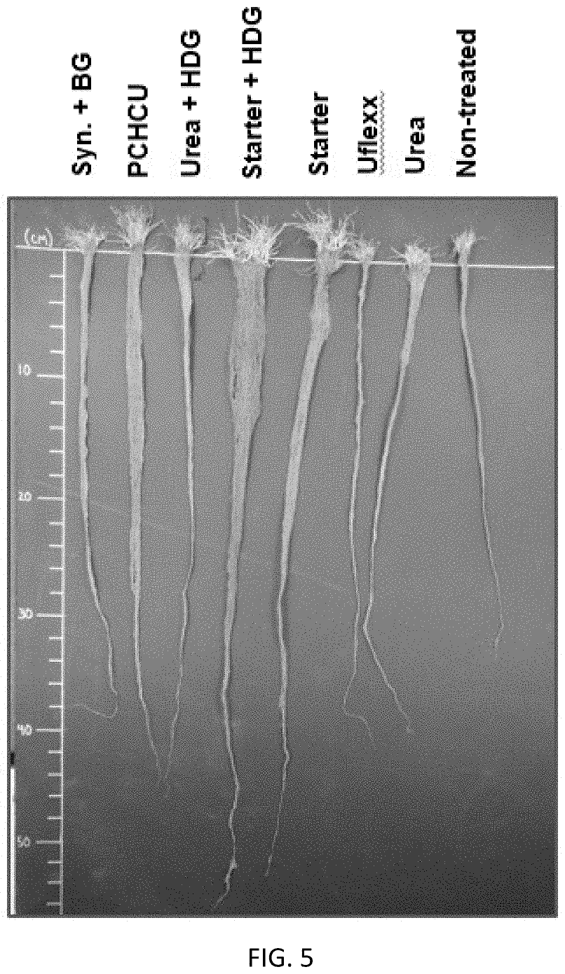

The turfgrass samples are harvested at 120 days after seeding. The samples are shown for comparison in FIG. 5 and are evaluated for total root length, root surface area, root volume, and root shoot biomass. The results of this evaluation are presented in Table 2.

TABLE 2
Turfgrass Rooting Evaluation Data.

| | | | Total | Root | | Root |
|---|---|---|---|---|---|---|
| | | Longest | Root | Surface | Root | Bio- |
| | Nutrient | Root | Length | Area | Volume | mass |
| Treatment | Analysis | cm | cm | cm² | cm³ | g |
| Synthetic | 22-0-4, 30% | 44.0 | 2884 | 150 | 0.62 | 0.09 |
| Fertilizer w/ | gypsum, | | | | | |
| Black | 4.7% humic | | | | | |
| Gypsum | acid | | | | | |
| Inventive | 45-0-0.2, | 47.7 | 3572 | 184 | 0.75 | 0.10 |
| poly-coated | 2% HA | | | | | |
| humic- | | | | | | |
| coated urea | | | | | | |
| (PCHCU) | | | | | | |
| Urea + HDG | 46-0-0 + | 44.2 | 3117 | 154 | 0.61 | 0.08 |
| | 70% HA | | | | | |
| Starter | 18-24-12 + | 53.3 | 5508 | 333 | 1.61 | 0.25 |
| Fertilizer + | 70% HA | | | | | |
| HDG | | | | | | |
| Starter | 18-24-12 | 54.2 | 5334 | 327 | 1.61 | 0.24 |
| Fertilizer | | | | | | |
| alone | | | | | | |
| Uflexx | 46-0-0 | 39.9 | 2145 | 103 | 0.39 | 0.06 |
| Urea | 46-0-0 | 42.3 | 2601 | 130 | 0.51 | 0.07 |
| Non-treated | No added | 39.7 | 1704 | 85 | 0.34 | 0.05 |
| | nutrients | | | | | |
| | LSD_{0.05} | 6.1 | 495 | 33 | 0.20 | 0.04 |

All data collected were subjected to analysis of variance (ANOVA) with repeated measures using SAS (version 9.4). Notably, the humic substance provides only minimal benefit to the root length when applied with a starter fertilizer, as demonstrated by the comparison of the sample treated with only starter fertilizer compared to the sample treated with the starter fertilizer and the HDG, which is a product called HUMIC DG™ sold by The Andersons, Inc. Surprisingly though, the data shows that the samples treated with an inventive granule exhibit root lengths surprisingly similar to the samples treated with the starter fertilizer, alone or with HDG as noted in the bolded rows of data. Accordingly, the embodiments of the inventive granule provide significant and surprising root growth without the use of a starter fertilizer, meaning that a starter fertilizer may be skipped altogether, thereby reducing costs to growers. Additional data as to the benefits of the present invention also exist. AJ Lindsey et al., “Evaluation of Humic Fertilizers Applied at Full and Reduced Nitrogen Rates on Kentucky Bluegrass Quality and Soil Health,” Agronomy 2021, 11, 395.

Any patents or publications mentioned in this specification are indicative of the level of those skilled in the art to which the invention pertains. These patents and publications are herein incorporated by reference to the same extent as if each individual publication was specifically and individually indicated to be incorporated by reference.

One skilled in the art will readily appreciate that the present invention is well adapted to carry out the objects and obtain the ends and advantages mentioned, as well as those inherent therein. The present methods, procedures, treatments, molecules, and specific compounds described herein are presently representative of preferred embodiments, are exemplary, and are not intended as limitations on the scope of the invention. Changes therein and other uses will occur to those skilled in the art which are encompassed within the spirit of the invention as defined by the scope of the claims.

1. A granule defined by a shape and a size comprising:
a mass formed of a plurality of soluble fertilizer particles and a plurality of humic particles; and
an extended-release polymer coating surrounding an exterior surface of said mass.

2. The granule of claim 1 wherein the size is of between 0.1 and 10 mm.

3. The granule of claim 1 wherein said plurality of humic particles are potassium humate.

4. The granule of claim 1 wherein said plurality of soluble fertilizer particles are urea.

5. The granule of claim 1 wherein said extended-release coating is water insoluble polymer.

6. The granule of claim 1 wherein said extended-release coating is biodegradable.

7. The granule of claim 1 wherein said extended-release coating is present from 0.5 to 18 total weight percent.

8. The granule of claim 1 wherein said extended-release coating a at least one of: a sodium salt of carboxylic acid copolymer dispersant and a polyol, a latex, a polyurethane, a polyurea, a polylactic acid, polycaprolactone, polybutylene succinate, polybutylene succinate adipate, aliphatic-aromatic copolyesters, polybutylene adipate/terephthalate, polymethylene adipate/terephthalate, and a copolymer including at least 50 weight percent of any of the aforementioned polymers.

9. The granule of claim 1 wherein said extended-release coating a at least one of: dextran, starch, poly((meth)acrylic acid), poly(vinyl hydroxyethylcellulose, alginates, agar, gelatin, mucilage and mixtures thereof.

10. The granule of claim 1 further comprising a particulate additive within said mass.

11. The granule of claim 1 further comprising an anti-dusting agent positioned between said mass and said extended-release coating.

12. The granule of claim 1 wherein said plurality of soluble fertilizer particles are admixed with said plurality of soluble fertilizer particles without a binder.

13. The granule of claim 1 wherein said plurality of soluble fertilizer particles form at least one soluble fertilizer-rich domain and said plurality of soluble fertilizer particles form at least one humic-rich domain fused to said at least one soluble fertilizer-rich domain as a surface coating around said at least one soluble fertilizer-rich domain.

14. A process of forming a granule of claim 1 comprising:
providing a mass of a plurality of soluble fertilizer particles and a plurality of humic particles; and
applying an extended-release coating to an exterior surface of said mass.

15. The process of claim 14 wherein said extended-release coating is applied by introducing said extended-release coating into said drum and mixing said mass with said extended-release coating.

16. The process of claim 14 wherein said extended-release coating and said mass are mixed in said drum for 3 to 15 minutes.

17. The process of claim 14 wherein said mass is formed by tackifying the soluble fertilizer particle surface in contact with said particles of humics to create adherence between the soluble fertilizer particle surface and said particles of humics to form said mass without resort to a binder.

18. The process of claim 14 further comprising overcoating said mass with an anti-dusting agent.

19. A method for enhancing root growth of a target plant comprising:
applying a plurality of granules of claim 1 to the target plant; and
allowing sufficient time for extended release of nutrients and humics from said plurality of granules.

20. The method of claim 19 wherein the target plant is turf grass.
